(19) United States
(12) Patent Application Publication
(10) Pub. No.: US 2005/0230054 A1
(43) Pub. Date: Oct. 20, 2005

(54) Calendering system for the production of webs of steel cable carcass

(75) Inventors: Gerd Capelle, Langenhagen (DE); Georg Reisswig, Hohenhameln (DE)

Correspondence Address: CROWELL & MORING LLP;INTELLECTUAL PROPERTY GROUP, P.O. BOX 14300, WASHINGTON, DC, 20044-4300, US

(73) Assignee: Berstorff GmbH, Hannover (DE)

(21) Appl. No.: 11/150,126

(22) Filed: Jun. 13, 2005

Related U.S. Application Data
(63) Continuation of application No. PCT/EP03/11771, filed on Oct. 24, 2003.

(30) Foreign Application Priority Data
Dec. 12, 2002 (DE) 102 58 353.6

(51) Int. Cl. B29C 70/50

(52) U.S. Cl. 156/437

(57) ABSTRACT

A calendering system, especially for producing webs of steel cable carcass, comprises two extruders for feeding plasticized material, a device for delivering steel cables, a calender that is provided with two pairs of rollers which rotate in opposite directions, each of said pairs encompassing a working roller and a sheeting roller. The calendering system further includes slot dies which are disposed between the extruders and the pairs of rollers and extend into sheeting gaps located between the pairs of rollers. A working gap is embodied between the working rollers so as to receive calendered webs released by the pairs of rollers and the steel cables fed by the steel cable delivering device as well as to discharge the web of steel cable carcass.

### CROSS-REFERENCE TO RELATED APPLICATIONS

This application is a continuation of PCT Application No. PCT/EP2003/011771 filed on Oct. 24, 2003, which claims priority to German Application No. 102 58 353.6 filed Dec. 12, 2002.

### BACKGROUND AND SUMMARY OF THE INVENTION

The invention relates to a calendering system for the production of webs of steel cable carcass, particularly for tires.

Steel cable carcasses for tires are conventionally produced in a calender with two barrel extruders, which each feed a plasticized caoutchouc paste to two pairs of rollers arranged above one another. Steel cables reeled off a spool carrier are placed by way of guides between the caoutchouc webs delivered by the pairs of rollers and are subsequently processed with the caoutchouc webs in a horizontal working gap to form the steel cable carcass.

In the case of such calendering systems, carcass thicknesses of up to 2 mm can be produced. The strand of material fed by the extruders forms a rolling hump in front of the sheeting gap formed between the rollers, which rolling hump tends to form cracks when larger carcass thicknesses are produced, whereby air can penetrate into the web of the carcass. Such inclusions of air clearly reduce the quality of the product.

It is an object of the invention to provide an improvement in comparison to the known calendering systems and, in particular, to permit the production of high-quality thick steel cable carcasses.

This object is achieved by providing a calendering system, particularly for the production of webs of steel cable carcass, having two extruders for feeding plasticized material, a steel cable feeding device for feeding steel cables, a calender which has a first pair of rollers rotating in opposite directions with a first working roller and a first sheeting roller, and a second pair of rollers rotating in opposite directions with a second working roller and a second sheeting roller, and a first sheet die provided between the first extruder and the first pair of rollers and projecting into a first sheeting gap between the first pair of rollers, and a second sheet die provided between the second extruder and the second pair of rollers and projecting into a second sheeting gap between the second pair of rollers, wherein a working gap is constructed between the working rollers, for receiving a first calendered web delivered by the first pair of rollers, a second calendered web delivered by the second pair of rollers, and the steel cables delivered by the steel cable feeding device, and for the delivery of the web of the steel cable carcass.

According to the invention, two roller head systems, each including an extruder, a sheet die and a two-roller calender, are therefore provided, which each produce a web of material, particularly a web of caoutchouc. The steel cables are fed directly, together with the webs of caoutchouc delivered by the two pairs of rollers, into a working gap between the working rollers of the two pairs of rollers and are machined to form a web of the carcass. As a result of the sheet dies projecting into the sheeting gaps between the working rollers and the sheeting rollers, a precalibration of the plastic material mass, that is, particularly of the caoutchouc, takes place, so that webs of material of a large thickness and a high quality can be produced.

Relatively small sheeting rollers can be used in this case, which offer additional advantages. They are cost-effective in their production and, because of the lower bearing load, require smaller and, therefore, more cost-effective bearings while the bearing wear is low. Since, because of the greater curvature of the small sheeting rollers, the sheeting gaps are smaller or shorter in the delivery direction, a lower power supply is required, so that the production costs and the wear can be reduced.

The wire cables are then fed into the working gap between the webs of caoutchouc. According to the invention, the working gap is vertically oriented while the pairs of rollers are arranged horizontally side-by-side, so that—in contrast to the initially described calenders—both pairs of rollers can be charged directly with plasticized material by the extruders by way of the sheet dies. In this case, both extruders can be set up at the ground level and their charging is therefore relatively easy. The sheet dies are advantageously oriented at a relatively small angle of, for example, 0° to 40° with respect to the horizontal line and, without any high losses of resistance, can receive the plastic material mass released from the barrel extruders. In particular, the horizontal alignment of the sheet dies is advantageous in this case because of the low resistance. The sheeting rollers are advantageously each arranged on the working rollers at an angle of from 50° to 90° with respect to the horizontal line. If required, the steel cables are placed by way of a deflecting roller or guiding roller just in front of the working gap for a defined depositing onto one of the two working rollers.

According to the invention, steel cable carcasses can, therefore, be produced which have thicknesses of from 0 to 30 mm, preferably from 0.5 to 10 mm without or virtually without, any inclusions of air. The calender consisting of four rollers can advantageously be housed in a single calender chassis.

Other objects, advantages and novel features of the present invention will become apparent from the following detailed description of the invention when considered in conjunction with the accompanying drawings.

### BRIEF DESCRIPTION OF THE DRAWINGS

FIG. 1 is a sectional view of a calendering system according to an embodiment of the invention;

FIG. 2 is a view of a cutout of FIG. 1; and

FIG. 3 is a view of a cutout corresponding to FIG. 2 according to another embodiment of the invention.

### DETAILED DESCRIPTION OF THE DRAWINGS

A calendering system 1 has two extruders 2, 3, a steel cable feeding device 4, and a calender 5 from which a steel cable carcass 6 is released.

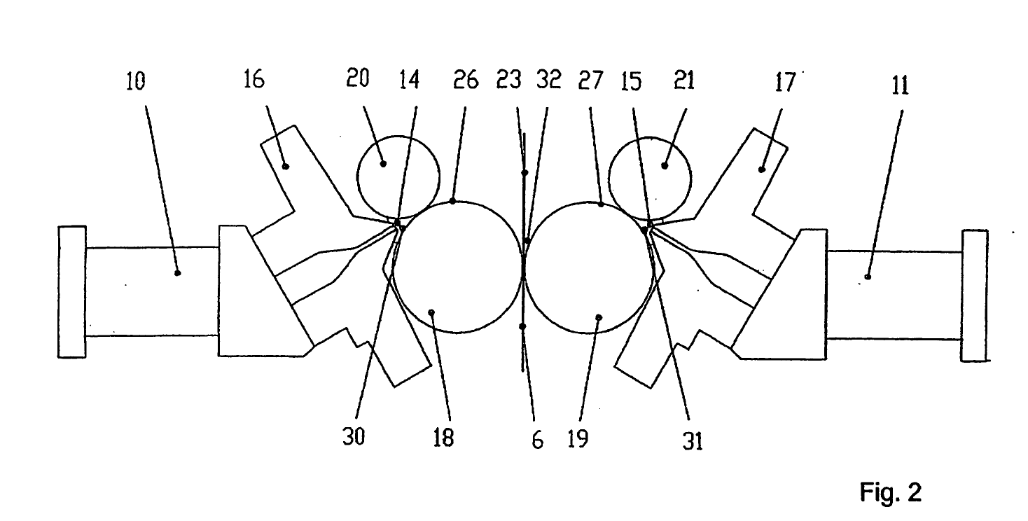

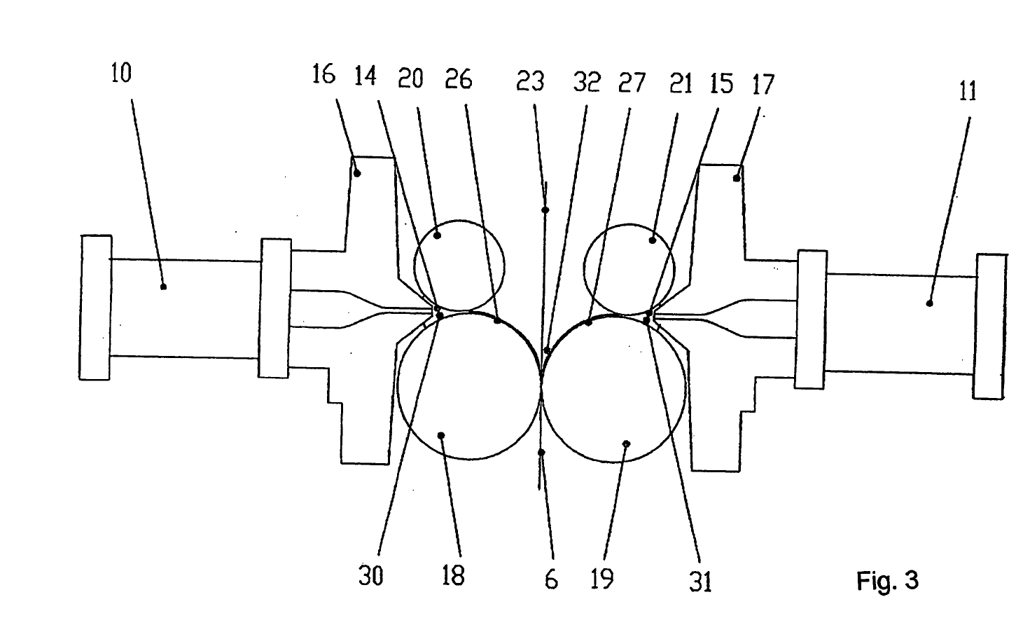

The extruders 2, 3 each have a funnel 8, 9 for receiving the material substance to be processed and a barrel extruder 10, 11 which delivers extrusion material 14 and 15, respectively, along their horizontally extending axes to a first sheet die 16 and a second sheet die 17, respectively (see FIGS. 2 and 3).

The calender 5 has a first pair of rollers with a first working roller 18 and a first sheeting roller 20, the two rollers 18, 20 rotating in opposite directions and being separated by a first sheeting gap 30 of a thickness of, for example, 0 to 15 mm. Correspondingly, a second pair of rollers has a second working roller 19 and a second sheeting roller 21 rotating in an opposite direction thereof. A second sheeting gap 31 corresponding to the first sheeting gap 30 is constructed between the rollers 19, 21. The plastic material 14 and 15, respectively, is fed by way of the respective sheet die 16, 17, distributed over the width of the sheeting gap 30, 31, between the two rollers of each pair of rollers 18, 20 and 19, 21 respectively, and is calendered to a first and second web of caoutchouc 26, 27 respectively. According to the invention, the calender 5 formed of the four rollers 18, 19, 20, 21 is received in a single calender chassis 34.

In a manner known per se, the steel-cable-feeding device 4 has a spool carrier 22 with steel cable spools, from which steel cables 23 are unreeled and are fed by way of wire cable guides 24 and a deflecting roller 25 to the calender 5. The steel cables 23 are placed directly in a working gap 32 between the working rollers 18, 19 or by way of another deflecting roller, for example, onto the first web of caoutchouc 26 just in front of the working gap 32. In this case, the working gap 32 is constructed as a vertical gap, so that the steel cables 23 can be placed vertically between the webs of caoutchouc 26, 27. The webs of caoutchouc 26, 27 and the steel cables 23 are calendered in the working gap 32 between the working rollers 18, 19 to form the web of the steel cable carcass 6.

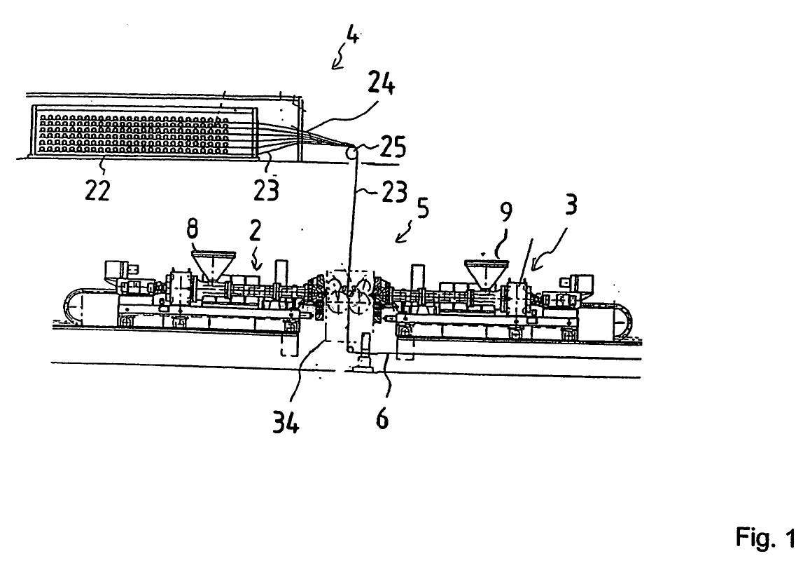

In the first embodiment of FIGS. 1 and 2, the sheet dies 16, 17 are bent at an obtuse angle with respect to the horizontal delivery direction of the barrel extruders 10, 11. In this case, the deflecting angle of the webs of caoutchouc 26, 27 on the working rollers 18, 19 from the sheeting gaps to the working gap is between 120 to 130°.

In the advantageous embodiment illustrated in FIG. 3, a horizontal feeding of the extrusion material 14 and 15 respectively takes place by way of the barrel extruders 10, 11 and the horizontally oriented sheet dies 16, 17 into the sheeting gaps 30, 31, so that the delivery resistance is reduced in comparison to the first embodiment. In this embodiment, the arrangement of the sheeting rollers 20, 21 above the working rollers correspondingly takes place at a larger angle with respect to the horizontal line than in the first embodiment.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A calendering system for producing webs of steel cable carcass, comprising:
two extruders for feeding plasticized material;
a steel cable feeding device for feeding steel cables;
a calender including first and second pairs of oppositely rotating rollers, each pair having a working roller and a sheeting roller;
a first sheet die arranged between a first extruder and the first pair of rollers, the first sheet die projecting into a first sheeting gap between the first pair of rollers;
a second sheet die arranged between a second extruder and the second pair of rollers, the second sheet die projecting into a second sheeting gap between the second pair of rollers;
a working gap formed between the working rollers of each pair of rollers for receiving: a first calendered web delivered by the first pair of rollers, a second calendered web delivered by the second pair of rollers, and the steel cables delivered by the steel cable feeding device, the working gap discharging the web of steel cable carcass.

2. The calendering system according to claim 1, wherein the working gap extends in a vertical direction.

3. The calendering system according to claim 1, wherein the two extruders are arranged essentially at one level, and the two pairs of rollers are arranged essentially horizontally side-by-side.

4. The calendering system according to claim 2, wherein the two extruders are arranged essentially at one level, and the two pairs of rollers are arranged essentially horizontally side-by-side.

5. The calendering system according to claim 1, wherein the calender is integrated in a single calender chassis.

6. The calendering system according to claim 1, wherein the sheeting rollers are each arranged on their respective working rollers at an angle of from 50° to 90° with respect to a horizontal line.

7. The calendering system according to claim 2, wherein the sheeting rollers are each arranged on their respective working rollers at an angle of from 50° to 90° with respect to a horizontal line.

8. The calendering system according to claim 1, wherein the sheeting rollers are smaller than their respective working rollers.

9. The calendering system according to claim 2, wherein the sheeting rollers are smaller than their respective working rollers.

10. The calendering system according to claim 6, wherein the sheeting rollers are smaller than their respective working rollers.

11. The calendering system according to claim 1, wherein the discharged web of steel cable carcass has a web thickness of from 0.5 to 30 mm.

12. The calendering system according to claim 1, wherein the discharged web of the steel cable carcass has a web thickness of from 0.5 to 10 mm.

13. The calendering system according to claim 1, wherein, as a result of the first and second sheet dies, a precalibrated plastic mass is distributable over an entire width of the sheeting gaps.

14. The calendering system according to claim 1, wherein axes of the two extruders and of the sheet dies extend in a horizontal direction.

15. The calendering system according to claim 2, wherein axes of the two extruders and of the sheet dies extend in a horizontal direction.

16. The calendering system according to claim 3, wherein axes of the two extruders and of the sheet dies extend in a horizontal direction.

17. The calendering system according to claim 1, wherein the sheet dies are arranged at an angle with respect to the axes of their respective extruders.

18. The calendering system according to claim 2, wherein the sheet dies are arranged at an angle with respect to the axes of their respective extruders.

19. A calendering system for use with two extruders that feed plasticize material in order to form webs of steel cable carcass, the calendering system comprising:
a calender having a first pair of rollers rotating in opposite directions and a second pair of rollers rotating in opposite directions, each pair of rollers including a working roller and a sheeting roller oriented with respect to one another to form a sheeting gap in between;
a first sheet die projecting into a first sheeting gap formed between the first pair of rollers and a second sheet die projecting into a second sheeting gap formed between the second pair of rollers;
wherein the first and second pairs of rollers are oriented to form a working gap between the respective working rollers, whereby the working gap receives a first calendered web delivered by the first pair of rollers, a second calendered web delivered by the second pair of rollers, and steel cables in order to discharge the web of steel cable carcass.

20. The calendering system according to claim 19, wherein the working gap is arranged in a vertical direction, and further wherein the sheeting rollers are each arranged on their respective working rollers at an angle of from 50° to 90° relative to a horizontal line, the sheeting rollers being smaller than their respective working rollers.
